(19) United States
(12) Patent Application Publication
(10) Pub. No.: US 2009/0161873 A1
(43) Pub. Date: Jun. 25, 2009

(54) METHOD AND APPARATUS FOR KEY MANAGEMENT IN AN END-TO-END ENCRYPTION SYSTEM

(76) Inventors: Frederic Simard, Nepean (CA); Behrouz Nikpour, Gloucester (CA); Xiaoqing-Richard Hu, Kanata (CA)

Correspondence Address: SMART & BIGGAR, 1000 DE LA GAUCHETIERE ST. W., SUITE 3300, MONTREAL, QC, H3B 4W5, CA

(21) Appl. No.: 11/960,208

(22) Filed: Dec. 19, 2007

(51) Int. Cl. H04L 9/06

(52) U.S. Cl. 380/277

(57) ABSTRACT

A method executed by a first network entity in communication with a second network entity. The method comprises maintaining a first key bank containing a key designated as an active key for the first network entity; maintaining a second key bank containing a key designated as a standby key for the first network entity; encrypting data for transmission to the second network entity using the active key for the first network entity; attempting to detect a match between (i) a representation of the standby key for the first network entity and (ii) a representation of a standby key for the second network entity received from the second network entity; and upon detecting a match, causing the active key for the first network entity to designate thereafter the key contained in the second key bank.

### FIELD OF THE INVENTION

The present invention relates generally to systems for key-based encryption and decryption of data and, more particularly, to a method apparatus for managing the keys used in such systems in order to effect various functions.

### BACKGROUND

There is an ever increasing need for data transmission at high rates. To take a specific example, companies in various industries are moving towards replication of large amounts of stored data (i.e., mirroring) across two or more proprietary but geographically distributed sites, in order to comply with various regulatory requirements such as Sarbanes-Oxley in the United States and similar provisions elsewhere. In many cases, the data exchanged between two proprietary sites will have to traverse a data network that may be friendly to a competitor or, worse still, may be publicly accessible. Thus, the need for encryption in these and other end-to-end systems is high.

Moreover, to ensure that the encryption process is sufficiently secure to meet corporate and/or regulatory requirements, the keys used in the encryption process must be changed often. That is to say, a “key management” process needs to be implemented. Typically where remote locations are involved, the key management process has been fairly rudimentary. For example, an operator may at time T1 log into a machine used at site A in order to enter an encryption key, and subsequently at time T2 may log into a machine used at site B in order to enter the appropriate decryption key. To prevent data traffic from being incorrectly decrypted at site B between time T1 and time T2, the encryption process is halted during this period. At low rates, this may not lead to a detectable problem, but at high rates, even several seconds of postponement may result in an excessive backlog of traffic to be sent from site A to site B.

It should further be appreciated that the need to change keys frequently, the possibility of human error and the potentially large number of combinations of site pairs all tend to increase the complexity of the key management process, the burden on IT personnel and the overall system down time.

Against this background, there is clearly a need in the industry for an improved key management solution, particularly at high data rates.

### SUMMARY OF THE INVENTION

A first broad aspect of the present invention seeks to provide a method executed by a first network entity in communication with a second network entity. The method comprises maintaining a first key bank containing a key designated as an active key for the first network entity; maintaining a second key bank containing a key designated as a standby key for the first network entity; encrypting data for transmission to the second network entity using the active key for the first network entity; attempting to detect a match between (i) a representation of the standby key for the first network entity and (ii) a representation of a standby key for the second network entity received from the second network entity; and upon detecting a match, causing the active key for the first network entity to designate thereafter the key contained in the second key bank.

A second broad aspect of the present invention seeks to provide a first network entity for communication with a second network entity. The first network entity comprises a first key bank containing a key designated as an active key for the first network entity; a second key bank containing a key designated as a standby key for the first network entity; an encryption module configured to encrypt data for transmission to the second network entity using the active key for the first network entity; and a controller configured to detect a match between (i) a representation of the standby key for the first network entity and (ii) a representation of a standby key for the second network entity received from the second network entity. Upon detecting a match, the controller is configured to cause the active key for the first network entity to designate thereafter the key contained in the second key bank.

A third broad aspect of the present invention seeks to provide a first network entity for communication with a second network entity. The first network entity comprises means for maintaining a first key bank containing a key designated as an active key for the first network entity; means for maintaining a second key bank containing a key designated as a standby key for the first network entity; means for encrypting data for transmission to the second network entity using the active key for the first network entity; means for detecting a match between (i) a representation of the standby key for the first network entity and (ii) a representation of a standby key for the second network entity received from the second network entity; and means for responding to detection of a match by causing the active key for the first network entity to designate thereafter the key contained in the second key bank.

A fourth broad aspect of the present invention seeks to provide a computer-readable medium comprising computer-readable program code which, when interpreted by a computing entity, causes the computing entity to execute a method of communicating with a second network entity. The computer-readable program code comprises first computer-readable program code for causing the computing entity to maintain a first key bank containing a key designated as an active key for the first network entity; second computer-readable program code for causing the computing entity to maintain a second key bank containing a key designated as a standby key for the first network entity; third computer-readable program code for causing the computing entity to encrypt data for transmission to the second network entity using the active key for the first network entity; fourth computer-readable program code for enabling the computing entity to detect a match between (i) a representation of the standby key for the first network entity and (ii) a representation of a standby key for the second network entity received from the second network entity; and fifth computer-readable program code for causing the computing entity to respond to detection of a match by causing the active key for the first network entity to designate thereafter the key contained in the second key bank.

A fifth broad aspect of the present invention seeks to provide a system, which comprises a first network entity and a second network entity communicatively coupled to the first network entity. The first network entity comprises a first key bank containing a key designated as an active key for the first network entity; a second key bank containing a key designated as a standby key for the first network entity; and an encryption module configured to produce a stream of data elements for the second network entity, each data element having a header and a payload, wherein the payload comprises (i) a first segment comprising input data encrypted using the active key for the first network entity and (ii) a second segment comprising an indication of the key bank that contains the active key for the first network entity. The second network entity comprises a third key bank corresponding to the first key bank in the first network entity; a fourth key bank corresponding to the second key bank in the first network entity; and a decryption module configured to process the stream of data elements from the first network entity to determine the contents of the respective second segments and to decrypt the respective first segments using the contents of the respective first segments, thereby to recover the input data.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram of a system for end-to-end data encryption between a first network entity and a second network entity, in accordance with a non-limiting embodiment of the present invention.

FIG. 2A shows contents of a memory at the first network entity, applicable to a symmetric key structure.

FIG. 2B shows contents of a memory at the first network entity, applicable to an asymmetric key structure.

FIG. 3 illustrates operation of an encryption module within the first network entity.

FIG. 4 shows how the contents of the memory in FIG. 2A progresses over time following rollover in accordance with a particular non-limiting example embodiment.

FIGS. 5A and 5B are block diagrams illustrating control messages exchanged between the first and second network entities that allow the first network entity to detect a standby key mismatch condition.

FIG. 6 shows how the contents of the memory in FIG. 2A progresses over time following rollover in accordance with another particular non-limiting example embodiment.

It is to be expressly understood that the description and drawings are only for the purpose of illustration of certain embodiments of the invention and are an aid for understanding. They are not intended to be a definition of the limits of the invention.

### DETAILED DESCRIPTION

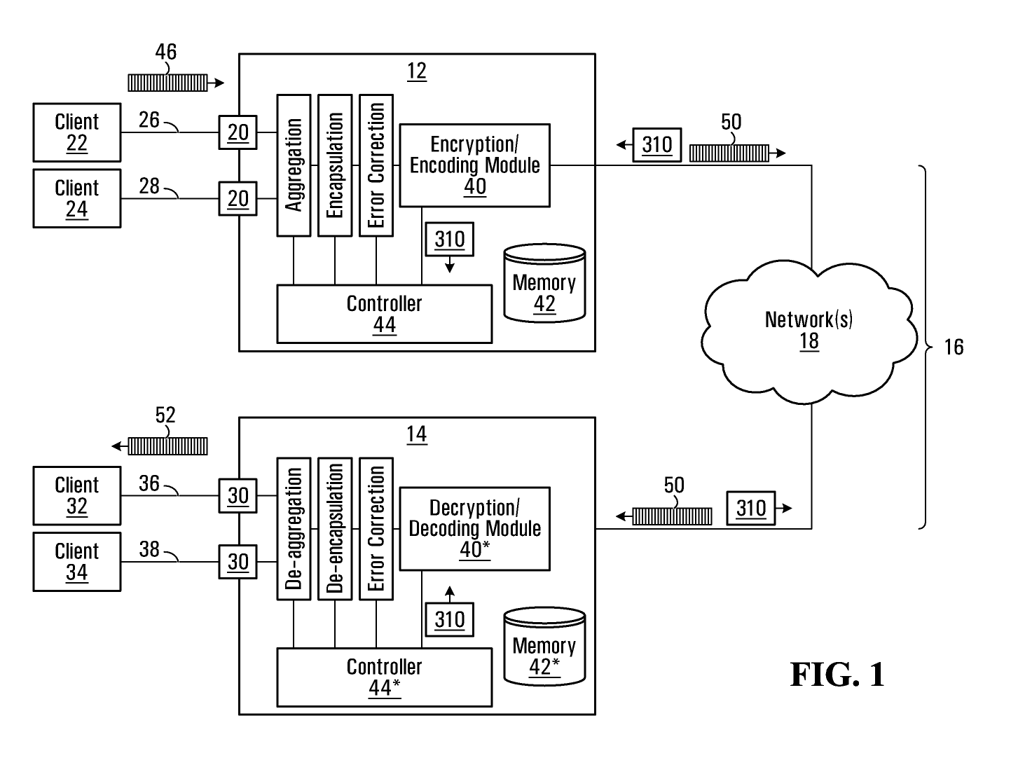

Reference is made to FIG. 1, which shows a system for end-to-end encryption of data. The system comprises a first network entity 12 connected to a second network entity 14 over a communication link 16. The communication link 16, which can be physical, logical or a combination thereof, may span one or more data networks 18, which in a non-limiting example embodiment may include a public packet-switched network such as the Internet. In a non-limiting example embodiment, the first network entity 12 comprises a plurality of input/output ports 20, each connected to a respective one of a plurality of clients 22, 24 over a respective one of a plurality of links 26, 28. Similarly, in a non-limiting example embodiment, the second network entity 14 comprises a plurality of input/output ports 30, each connected to a respective one of a plurality of clients 32, 34 over a respective one of a plurality of links 36, 38.

In non-limiting embodiments, the clients 22, 24, 32, 34 may be Ethernet switches or Fiber Channel switches, for example. In the case of Ethernet switches, these could in turn be connected to LAN traffic originating from servers/computers while in the case of Fiber Channel switches, these could in turn be connected to disk/storage arrays. Still other possibilities are within the scope of the present invention. For the purposes of the present example, only four clients 22, 24, 32, 34 are illustrated, but it should be appreciated that the number of clients is not particularly limited.

The first and second network entities 12, 14 may also be reachable via an auxiliary network that allows an operator or other party to effect a remote login operation. In a non-limiting example embodiment, this auxiliary network may be the aforesaid public packet-switched network or another network.

Links 26, 28 are in this example bidirectional but in an alternative embodiment they can each comprise a pair of unidirectional links. In one direction, links 26, 28 carry data from clients 22, 24 that is destined for respective remote clients. In the present example, let these remote clients be clients 32, 34, which are connected to the second network entity 14. As can be appreciated, the data transmitted from clients 22, 24 and destined for clients 32, 34 arrives at and is processed by the first network entity 12. Specifically, the first network entity 12 applies various functions to the data, such as aggregation, encapsulation, error coding and encryption, to name a few non-limiting possibilities. To this end, the first network entity 12 comprises suitable circuitry, control logic and/or software for executing the relevant functions. One function of particular interest is encryption, which is performed by an encryption/encoding module denoted by the reference numeral 40. The encryption/encoding module 40 may be implemented in hardware, software, control logic or a combination thereof. Thus, the encryption/encoding module 40 executes an encryption function on the data arriving from clients 22, 24.

In the opposite direction, links 26, 28 carry data from clients 32, 34 that is destined for clients 22, 24, respectively. As can be appreciated, the data arriving from clients 32, 34 over the communication link 16 and destined for clients 22, 24 arrives at and is processed by the first network entity 12. Specifically, the first network entity 12 applies various functions to the data that are the inverse of those described above, and thus include functions such as decryption, error correction, de-encapsulation and de-aggregation, to name a few non-limiting possibilities. To this end, the first network entity 12 comprises suitable circuitry, control logic and/or software for executing the relevant functions.

Analogously, links 36, 38 are in this example bidirectional but in an alternative embodiment they can each comprise a pair of unidirectional links. In one direction, links 36, 38 carry data from clients 32, 34 that is destined for clients 22, 24, respectively. As can be appreciated, the data arriving from clients 32, 34 and destined for clients 22, 24 arrives at and is processed by the second network entity 14. Specifically, the second network entity 14 applies various functions to the data, such as aggregation, encapsulation, error coding and encryption, to name a few non-limiting possibilities. To this end, the second network entity 14 comprises suitable circuitry, control logic and/or software for executing the relevant functions.

In the opposite direction, links 36, 38 carry data from clients 22, 24 that is destined for clients 32, 34, respectively. As can be appreciated, the data transmitted from clients 22, 24 over the communication link 16 and destined for clients 32, 34 arrives at and is processed by the second network entity 14. Specifically, the second network entity 14 applies various functions to the data that are the inverse of those described above, and thus include functions such as decryption, error correction, de-encapsulation and de-aggregation, to name a few non-limiting possibilities. To this end, the first network entity 12 comprises suitable circuitry, control logic and/or software for executing the relevant functions. One function of particular interest is decryption, which is performed by a decryption/decoding module denoted by the reference numeral 40*. The decryption/decoding module 40* may be implemented in hardware, software, control logic or a combination thereof. Thus, the decryption/decoding module 40* executes an encryption function on the data arriving from clients 22, 24, such data having been encrypted by the encryption/encoding module 40 in the first network entity 12.

The first network entity 12 also comprises a memory 42 and a controller 44, while the second network entity 14 correspondingly comprises a memory 42* and a controller 44*. In the context of communication in the direction from client 22 to client 32, the memory 42 stores a set of keys and other parameters used by the encryption/encoding module 40 for executing the encryption function and by the controller 44 for executing a “key management” function. For its part, the memory 42* stores a corresponding set of keys and other parameters used by the decryption/decoding module 40* for executing the decryption function and by the controller 44* for executing a corresponding “key management” function. Further details regarding the encryption function, the decryption function and the key management functions will be provided following a brief description of the keys and other parameters stored in the memory 42 and the memory 42*.

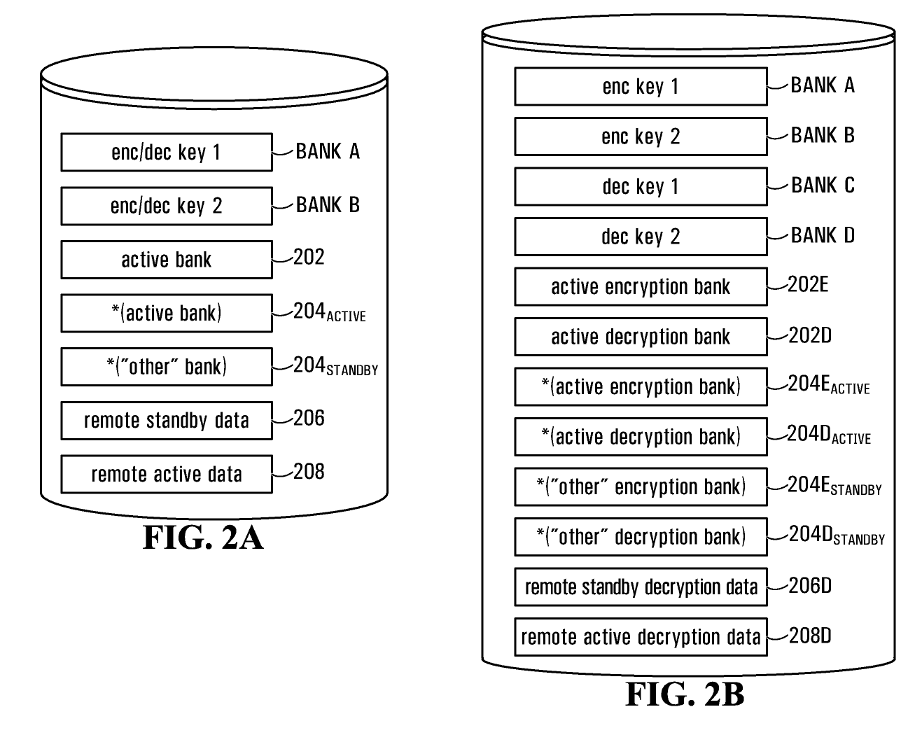

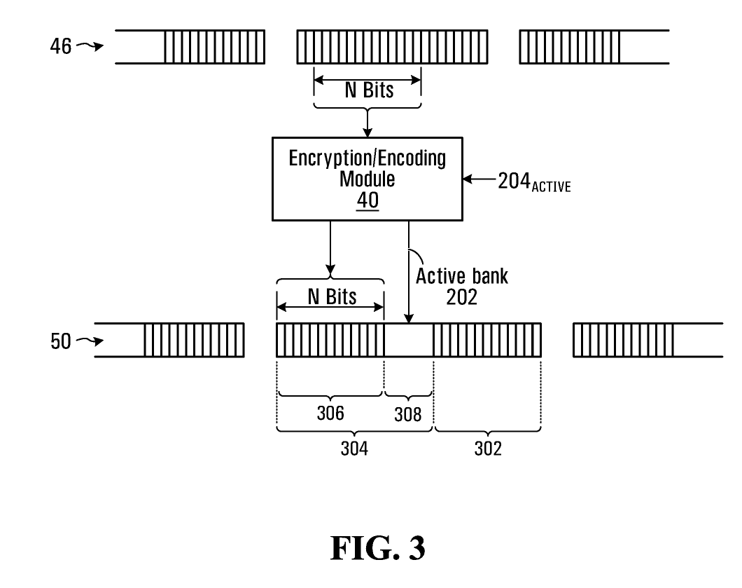

Specifically, consider a specific client data stream 46 originating from client 22 and whose contents are destined for client 32. With additional reference to FIG. 2A, the memory 42 maintains a set of data elements in order to support the encryption function executed by the encryption/encoding module 40 on the specific client data stream 46. These data elements can be identified as follows:
a first key bank (hereinafter “BANK A”), whose contents are an encryption key that can be used for encryption of the specific client data stream 46;
a second key bank (hereinafter “BANK B”), whose contents are another encryption key that can be used for encryption of the specific client data stream 46;
an active key bank designator 202, whose contents are the identity of a key bank (selected from BANK A and BANK B) whose contents are to be used for encryption of the specific client data stream 46 at the current time;
an active key 204_{ACTIVE}, which corresponds to the contents of the key bank currently identified by the active key bank designator 202. In other words, if the contents of the active key bank designator 202 is “BANK A”, then the active key 204_{ACTIVE} corresponds to the contents of BANK A, while if the contents of the active key bank designator 202 is “BANK B”, then the active key 204_{ACTIVE} corresponds to the contents of BANK B;
a standby key 204_{STANDBY}, which corresponds to the contents of a key bank that is not identified by the active key bank designator 202. Where there are two key banks (as in the present example), and if the contents of the active key bank designator 202 is “BANK A”, then the standby key 204_{STANDBY} corresponds to the contents of BANK B, while if the contents of the active key bank designator 202 is “BANK B”, then the standby key 204_{STANDBY} corresponds to the contents of BANK A. Where there are more than two key banks (say, BANK A, BANK B and BANK C), and if the contents of the active key bank designator 202 is “BANK A”, then the standby key 204_{STANDBY} can correspond to the contents of BANK B or BANK C.

At this juncture, it should be appreciated that the second network entity 14 can have the same structure as the first network entity 12. Thus, it should be appreciated that the memory 42* in the second network entity 14 stores its own version of BANK A, BANK B, the active key bank designator 202, the active key 204_{ACTIVE} and the standby key 204_{STANDBY} maintained in the memory 42 at the first network entity 12. Both versions of the aforesaid data elements are expected to be the same at the first and second network entities 12, 14, with some exceptions.

Specifically, a first occasion where there may be a difference between the data stored in the memory 42 at the first network entity 12 and the corresponding data stored in the memory 42* at the second network entity 14 is during a period of time preceding a “rollover” phase of the key management function (which will be described later in detail). During this period of time, a difference will exist between the version of the standby key 204_{STANDBY} stored in the memory 42 and the version stored in the memory 42*. The ability to detect this difference is part of the key management function executed by the controller 44. To this end, the memory 42 also maintains:
“remote standby data” 206, which corresponds to data received from the second network entity 14, and which is a representation of the version of the standby key 204_{STANDBY} stored in the memory 42* at the second network entity 14.

Another occasion where there may be a difference between the data stored in the memory 42 at the first network entity 12 and the corresponding data stored in the memory 42* at the second network entity 14 is pursuant to a malfunction. In such a case, a difference will exist between the version of the active key 204_{ACTIVE} stored in the memory 42 and the version stored in the memory 42*. The ability to detect this difference is part of the key management function executed by the controller 44. To this end, the memory 42 may also maintain:
“remote active data” 208, which corresponds to data received from the second network entity 14, and which is a representation of the version of the active key 204_{ACTIVE} stored in the memory 42* at the second network entity 14.

Naturally, where the second network entity 14 has the same structure as the first network entity 12, the memory 42* at the second network entity 14 will also maintain its own version of the remote standby data 206 and/or the remote active data 208, which is based on data received from the first network entity 12, and which is a representation of the version of the standby key 204_{STANDBY} and/or the active key 204_{ACTIVE} stored in the memory 42 at the first network entity 12.

The role of the various data elements referred to above will become apparent from the following description of the encryption function executed by the encryption/encoding module 40, the decryption function executed by the decryption/decoding module 40* and the key management function executed by the controllers 44, 44*, continuing with the context of communication in the direction from client 22 to client 32.

With continued reference to FIG. 1, the encryption function executed by the encryption/encoding module 40 referred to above will now be described with reference to the specific client data stream 46. As mentioned above, the specific client data stream 46 is received from client 22 and its contents are destined for client 32. For example, the specific client data stream 46 may contain data that is currently stored by client 22 and that is to be transmitted to, and re-stored by, client 32. Accordingly, the specific client data stream 46 can arrive at the first network entity 12 in any suitable format, including Fiber Channel (FC), which has applications in storage area networks and data replication. Applications other than data storage/replication are of course possible without departing from the scope of the present invention, as are other data formats, including Ethernet, ATM, IP, InfiniBand, SONET/SDH and iSCSI, to name a few non-limiting possibilities.

The encryption function transforms the specific client data stream 46 into an output data stream. The output data stream comprises a plurality of data elements hereinafter referred to as packets 50. The format of the packets 50 is not particularly limited, and it can be said that the packets 50 are simply formatted to be suitable for transmission over the communication link 16. For example, the packets 50 may be IP packets. Where the communication link 16 traverses a local area network, the packets 50 may be Ethernet packets. Still other possibilities exist without departing from the scope of the present invention.

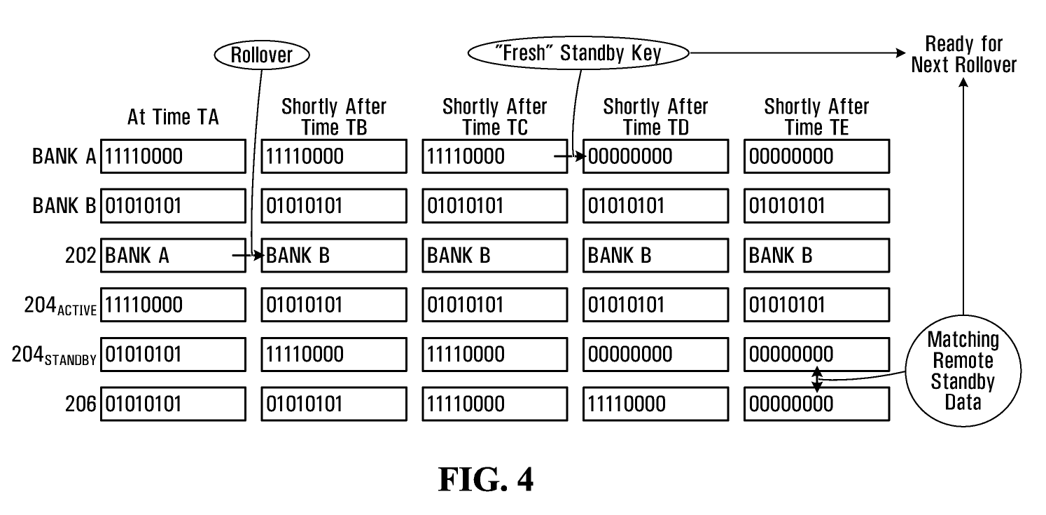

To simplify the following description, but without limiting the present invention, it will be assumed that the packets 50 are IP packets. With reference now to FIG. 3, each of the packets 50 comprises a header 302 and a payload 304. The header 302 can be a standard IP header, which can be in accordance with IPv4, IPv6, etc. The contents of the header 302 can originate from the controller 44 and is not encrypted. For its part, the payload 304 comprises a first segment 306 and a second segment 308. The first segment 306 comprises an encrypted version of a block of the specific client data stream 46. More particularly, in one specific non-limiting example embodiment, the encryption/encoding module 40 encrypts an N-bit block of data in the specific client data stream 46 with a specific encryption key using an encryption algorithm to yield an N-bit block of encrypted data that is placed into the first segment 306 of the payload 304.

In accordance with a non-limiting embodiment, the encryption algorithm can be in accordance with the advanced encryption standard (AES). In other embodiments, the encryption algorithm can be follow standards such as Data Encryption Standard (DES), Triple-DES or RSA. Still other possibilities exist without departing from the scope of the present invention.

In accordance with a non-limiting embodiment, the specific encryption key used in the encryption algorithm is the active key 204_{ACTIVE}. As explained earlier, the active key 204_{ACTIVE} (i.e., the encryption key used to encrypt N-bit blocks of data in the specific client data stream 46) corresponds to the contents of either BANK A or BANK B, depending on the key bank identified by the active key bank designator 202. To inform the second network entity 14 as to which is the relevant key bank (BANK A or BANK B), it is within the scope of the invention for the active key bank designator 202 to be encoded into the second segment 308 of the payload 304. Thus, if the key bank designated by the active key bank designator 202 is BANK A, then “BANK A” is encoded into the second segment 308 of the payload 304, while if the key bank designated by the active key bank designator 202 is BANK B, then “BANK B” is encoded into the second segment 308 of the payload 304.

It is recalled that the second network entity 14 is expected to maintain in the memory 42* the same data elements as the first network entity 12, except (i) during a pre-rollover phase—where the version of the standby key 204_{STANDBY} stored in the memory 42 and the version stored in the memory 42* will differ—and (ii) pursuant to a malfunction. Thus, unless there has been a malfunction, it will be apparent that the second network entity 14 stores the correct version of the active key 204_{ACTIVE} that was used to encrypt the data in the first segment 306 of the payload 304, and which is indirectly identified by the active key bank identifier 202 encoded into the second segment 308 of the payload 304.

With continued reference to FIGS. 1 and 3, the decryption function executed by the decryption/decoding module 40* referred to above will now be described with reference to the packets 50 once they are received at the second network entity 14. The header 302 in each of the packets 50 is processed by the controller 44*, which determines that the payload 304 is indeed destined for client 32. The payload 304 is then processed by the decryption/decoding module 40*. Specifically, the second segment 308 in the payload 304 encodes the active bank key identifier 202, which specifies that either BANK A or BANK B contains the active key 204_{ACTIVE} Once the decryption/decoding module 40* obtains the active key 204_{ACTIVE} by consulting the appropriate key bank in the memory 42*, the data in the first segment 306 of the payload 304 is decrypted using a decryption algorithm, in order to reveal an N-bit block of data. Successive N-bit blocks of data decrypted in this manner are then reconstructed into a client data stream 52 that is transmitted to client 32 over link 36.

It should be noted that where a symmetric key structure is used, the decryption algorithm is the same as the encryption algorithm, examples of which were previously given. In other embodiments, an asymmetric key structure can be used, whereby the decryption algorithm is complementary but not identical to the encryption algorithm. In such a scenario, and with reference now to FIG. 2B, the memory 42 in the first network entity 12 maintains an active encryption key 204E_{ACTIVE}, a standby encryption key 204E_{STANDBY}, an active decryption key 204D_{ACTIVE} and a standby decryption key 204D_{STANDBY}, in addition to remote standby decryption data 206D and remote active decryption data 208D. In addition, multiple key banks are provided. For example, each of BANK A and BANK B (at both the first network entity 12) can include both an encryption key and a decryption key. Alternatively, as illustrated in FIG. 2B, BANK A and BANK B could be reserved for maintaining the active and standby encryption keys, while a separate pair of banks (e.g., BANK C and BANK D) are used for maintaining the active and standby decryption keys. Still further variants can be devised without departing from the scope of the present invention.

The key management functions executed by the controllers 44, 44* are now described, continuing with the context of communication in the direction from client 22 to client 32. Specifically, as part of the key management function, the controller 44 may be configured to execute the following sub-functions:
(i) determine whether the version of the standby key 204_{STANDBY} stored in the memory 42 at the first network entity 12 corresponds to the version stored in the memory 42* at the second network entity 14 and signal the result (either match or mismatch). Also determine whether the version of the active key 204_{ACTIVE} stored in the memory 42 at the first network entity 12 corresponds to the version stored in the memory 42* at the second network entity 14 and signal the result (either match or mismatch);
(ii) at a strategically selected moment, change the active key bank designator 202 so that it now contains the identity of the “other” key bank. This can be referred to as “rollover”. Since the encryption/encoding module 40 utilizes the contents of the active key bank designator 202 to execute the encryption function, rollover has the effect of changing the key used by the encryption/encoding module 40, which enhances security.

The above sub-functions of the key management function executed by the controller 44 in the first network entity 12 are now described in further detail, with occasional reference to certain participation from the controller 44* in the second network entity 14. As will become apparent, sub-function (ii) may use some of the results of sub-function (i) to achieve advantageous performance.

Specifically, in order to execute sub-function (i) listed above, and with continued reference to FIG. 1, the controller 44 is configured to receive control messages 310 from the second network entity 14. The control messages 310 can be generated by the controller 44*(as part of its own key management function) and interspersed amongst packets destined for the first network entity 12. Alternatively, the control messages 310 can be sent over a completely separate channel, such as one that utilizes a different communication link than the communication link 16.

In accordance with a non-limiting embodiment of the present invention, the control messages 310 include data that allows the controller 44 to determine whether the version of the standby key 204_{STANDBY} stored in the memory 42 at the first network entity 12 corresponds to the version stored in the memory 42* at the second network entity 14. To this end, under a first option, the control messages 310 may comprise the version of the standby key 204_{STANDBY} stored in the memory 42*. Upon receipt of the control messages 310 at the first network entity 12, the version of the standby key 204_{STANDBY} stored in the memory 42* would then be extracted and stored as the remote standby data 206 in the memory 42. In this case, the controller 44 simply compares the standby key 204_{STANDBY} to the remote standby data 206 in order to declare a match or a mismatch. If a mismatch is declared, such a condition could be signaled to an operator to alert him/her that there is a situation where the two network entities 12, 14 have differing standby keys.

Another, potentially more secure, option would be for the controller 44* at the second network entity 14 to process its version of the standby key 204_{STANDBY} by way of a hash function (for example, but without limitation: SHA) known also to the controller 44, and then to include the resultant output into the control messages 310. Upon receipt of the control messages 310 at the first network entity 12, the output of the hash function performed by the controller 44* would be extracted and stored as the remote standby data 206 in the memory 42. In this case, the controller 44 applies the same hash function to the standby key 204_{STANDBY} stored in the memory 42 and compares the resultant output to the remote standby data 206 in order to declare a match or a mismatch. Again, if a mismatch is declared, such a condition could be signaled to an operator to alert him/her that there is a situation where the two network entities 12, 14 have differing standby keys.

A potentially even more secure option would be for the controller 44* at the second network entity 14 to encrypt its version of the standby key 204_{STANDBY} with itself, and then to include the result (or a hashed version thereof) into the control messages 310. A pre-determined initial vector could be use for the encryption. Upon receipt of the control messages 310 at the first network entity 12, the self-encrypted version of the standby key 204_{STANDBY} stored in the memory 42*(or the hashed version thereof) would be extracted and stored as the remote standby data 206 in the memory 42. In this case, the controller 44 encrypts the 204_{STANDBY} stored in the memory 42 with itself (and hashes it, if applicable) and compares the result to the remote standby data 206 in order to declare a match or a mismatch. Here again, if a mismatch is declared, such a condition could be signaled to an operator to alert him/her that there is a situation where the two network entities 12, 14 have differing standby keys.

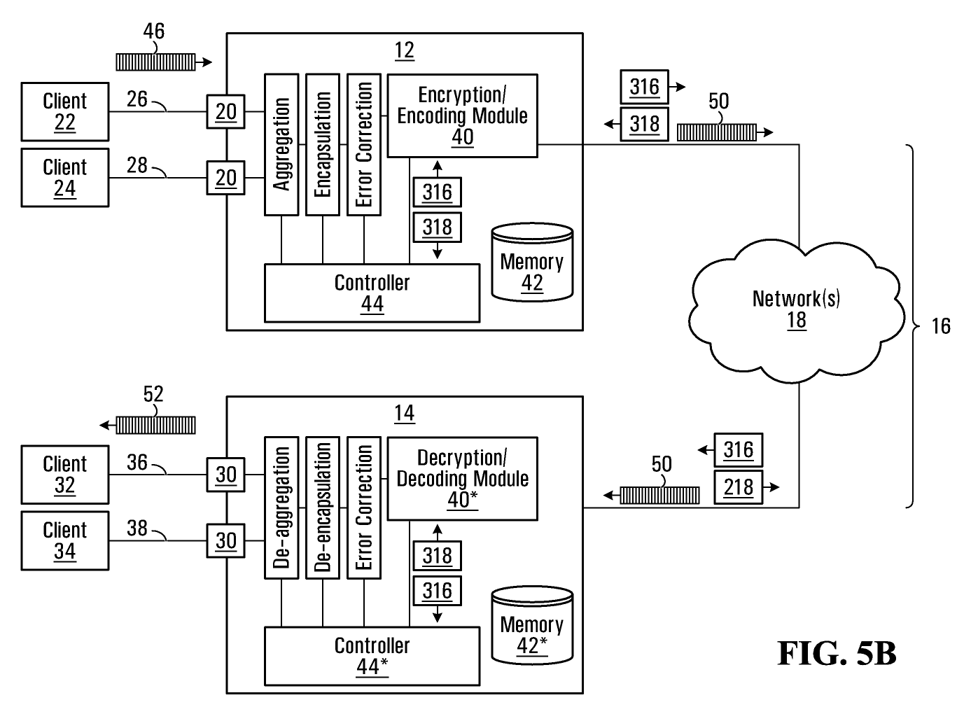

In an asymmetric key scenario, the control messages 310 from the second network entity 14 could include data that allows the first network entity 12 to determine whether the standby decryption key 204D_{STANDBY} used by the second network entity 14 is complementary to the standby encryption key 204E_{STANDBY} maintained in the memory 42 of the first network entity 12. To this end, and with reference to FIG. 5A, the controller 44 at the first network entity 12 can issue a challenge to the controller 44* at the second network entity 14. This can involve generating a random number (and storing it as the remote standby decryption data 206D in the memory 42), encrypting the random number using the standby encryption key 204E_{STANDBY}, encapsulating the encrypted random number in a control message 312 sent to the second network entity 14 and awaiting a response. Meanwhile, the controller 44* at the second network entity 14 receives the control message 312, decrypts the encrypted random number using its version of the standby decryption key 204D_{STANDBY} and places the result into a response message 314. When the version of the standby decryption key 204D_{STANDBY} stored in the memory 42* is complementary to the version of the standby encryption key 204E_{STANDBY} stored in the memory 42, then the result returned via the response packet 314 will correspond to the random number that had been stored as the remote standby decryption data 206D in the memory 42.

Alternatively, with reference to FIG. 5B, the controller 44 at the first network entity 12 can issue another type of challenge to the controller 44* at the second network entity 14. Specifically, this can involve generating a random number, storing it as the remote standby decryption data 206D in the memory 42 and sending it to the second network entity in the form of a control message 316. The controller 44* at the second network entity 14 receives the control message 316, encrypts the random number contained therein using its version of the standby encryption key 204E_{STANDBY} and encapsulates the result into a response message 318. The controller 44 at the first network entity 14 receives the control message 318, and decrypts the encrypted random number contained therein using its version of the standby decryption key 204D_{STANDBY}. When the version of the standby encryption key 204E_{STANDBY} stored in the memory 42* is complementary to the standby decryption key 204D_{STANDBY} stored in the memory 42, then the result of decryption by the controller 44 will correspond to the random number that had been stored as the remote standby decryption data 206D in the memory 42.

Still further variants of this challenge-response approach can be devised by persons skilled in the art, and such variants are within the scope of the invention.

As mentioned above, the controller 44 at the first network entity 12 may also be configured to monitor whether the version of the active key 204_{ACTIVE} stored in the memory 42 at the first network entity 12 corresponds to the version stored in the memory 42* at the second network entity 14. To this end, the same principles apply as those described above in respect of the standby key 204_{STANDBY} can be used, except that the control messages 310 may comprise the version of the active key 204_{ACTIVE} stored in the memory 42*, or a hash thereof, or a self-encrypted version thereof, etc., which would then be stored upon arrival as the remote active data 208 in the memory 42. A comparison would then be effected in the manner similar to that described above with respect to the remote standby data 206. If a mismatch is declared, such a condition could be signaled to an operator to alert him/her that the system appears to be malfunctioning.

Sub-function (ii) listed above, and its interaction with sub-function (i) described above, is best described using a non-limiting example of operation of the controller 44 in the first network entity 12. For the purposes of this example, it is assumed for simplicity that certain ones of the control messages 310 received from the second network entity 14 contain the version of the standby key 204_{STANDBY} stored in the memory 42*, and that it is this data which is stored as the remote standby data 206 in the memory 42. Those skilled in the art will easily appreciate how the example below can be extended to cases where the control messages 310 received from the second network entity 14 contain other (e.g., hashed, self-encrypted, etc.) versions of the standby key 204_{STANDBY} stored in the memory 42*. Also, those skilled in the art will appreciate that the behaviour of the controller 44* in the second network entity 14 can mirror that described below with respect to the controller 44 in the first network entity 12.

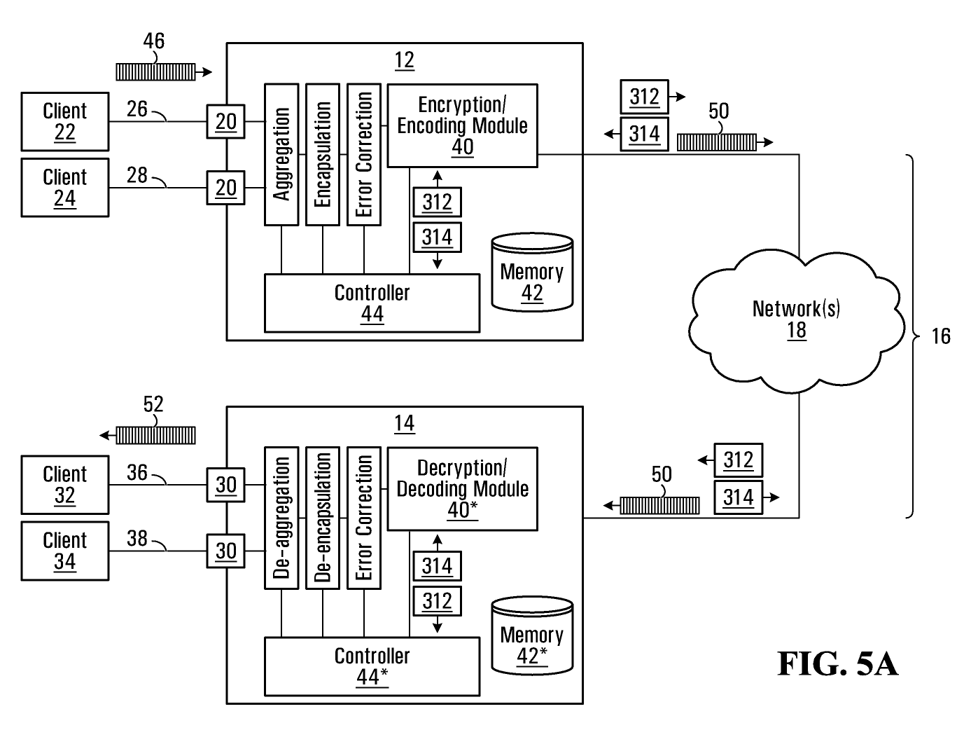

With additional reference now to FIG. 4, consider the case where at time TA, the memory 42 contains the following information (note that this particular example is not concerned with fluctuations in the remote standby data 208, and therefore this data element is not listed below nor shown in FIG. 4):
BANK A=11110000;
BANK B=01010101;
active key bank designator 202=BANK A;
active key 204_{ACTIVE}=*BANK A=11110000;
standby key 204_{STANDBY}=*BANK B=01010101;
remote standby data 206=01010101.

It is noted that the remote standby data 206 corresponds to the version of the standby key 204_{STANDBY} stored in the memory 42, which means that both network entities 12, 14 maintain the same standby key 204_{STANDBY} at time TA. This will cause the sub-function (i) to declare a standby key match condition.

At time TB, the controller 44 triggers “rollover”. A description of precisely when to trigger rollover is provided later on when discussing the next rollover operation. Rollover consists of the controller 44 changing the active key bank designator 202 so that it now identifies BANK B, namely the key bank where the standby key 204_{STANDBY} had been stored until just before time TB. From then on, BANK A, which formerly stored the active key 204_{ACTIVE}, will store what has now become the standby key 204_{STANDBY}. Specifically, with reference again to FIG. 4, the memory 42 contains the following information shortly after time TB:
BANK A=11110000;
BANK B=01010101;
active key bank designator 202=BANK B;
active key 204_{ACTIVE}=*BANK B=01010101;
standby key 204_{STANDBY}=*BANK A=11110000;
remote standby data 206=01010101.

It is noted that the remote standby data 206, for the time being, no longer corresponds to the version of the standby key 204_{STANDBY} stored in the memory 42. This will cause the sub-function (i) to declare a standby key mismatch condition. However, this is remedied as soon as rollover is triggered by the controller 44* in the second network entity 14, which can be triggered in much the same way as it was triggered by the controller 44 in the first network entity 12. In fact, it is within the scope of the present invention for rollover to be triggered simultaneously or quasi-simultaneously by both controllers 44, 44* based on parameters that they have been continuously monitoring. Thereafter, the second network entity 14 will send one or more control messages 310 encoding the version of the standby key 204_{STANDBY} stored in the memory 42*. These messages are received from the second network entity 14 and processed by the controller 44 at time TC. Thus, with reference again to FIG. 4, the memory 42 contains the following information shortly after time TC:
BANK A=11110000;
BANK B=01010101;
active key bank designator 202=BANK B;
active key 204_{ACTIVE}=*BANK B=01010101;
standby key 204_{STANDBY}=*BANK A=11110000;
remote standby data 206=11110000.

It is noted that the remote standby data 206 now does correspond to the version of the standby key 204_{STANDBY} stored in the memory 42, which means that both network entities 12, 14 maintain the same standby key 204_{STANDBY} from time TC onwards. However, the standby key 204_{STANDBY} is “stale” and thus it is recommended that the standby key 204_{STANDBY} be “refreshed” for security reasons. This is done by the controller 44 at time TD. Specifically, this is achieved by modifying the contents of the key bank where the standby key 204_{STANDBY} is located, i.e., the key bank that is NOT the one identified by the active key bank identifier 202.

Since the active key bank designator 202 contains “BANK B”, the contents of BANK A is modified. Two specific non-limiting embodiments are considered.

In a first specific embodiment, the contents of BANK A is modified to a brand new value (e.g., to “00000000”). For example, this modification can be done by an external operator directly or via remote login, or it can be done autonomously by software. Thus, with reference again to FIG. 4, the memory 42 contains the following information shortly after time TD:
BANK A=00000000;
BANK B=01010101;
active key bank designator 202=BANK B;
active key 204_{ACTIVE}=*BANK B=−01010101;
standby key 204_{STANDBY}=*BANK A=00000000;
remote standby data 206=11110000.

It is noted that, again, the remote standby data 206 for the time being no longer corresponds to the version of the standby key 204_{STANDBY} stored in the memory 42. Thus, the sub-function (i) described above will declare a standby key mismatch condition. However, unlike the situation at time TC, this difference in the version of the standby key 204_{STANDBY} is not remedied by triggering rollover. Rather, the standby key mismatch condition will persist until the same modification that was done to BANK A in the memory 42 is also done to BANK A in the memory 42*, that is to say, until the standby key 204_{STANDBY} is refreshed at the second network entity 14. In various non-limiting embodiments, this modification can be done by an external operator providing user input directly or via remote login, or autonomously by software.

Assume now that the contents of BANK A in the memory 42* at the second network entity 14 is ultimately modified. Shortly thereafter, the control messages 310 issued by the controller 44* will contain the new version of the standby key 204_{STANDBY} stored in the memory 42* at the second network entity 14. This data is received by the first network entity 12 and stored as the remote standby data 206 in the memory 42 upon receipt at time TE. Thus, with reference again to FIG. 4, the memory 42 contains the following information shortly after time TE:
BANK A=00000000;
BANK B=01010101;
active key bank designator 202=BANK B;
active key 204_{ACTIVE}=*BANK B=01010101;
standby key 204_{STANDBY}=*BANK A=00000000;
remote standby data 206=00000000.

It is noted that the remote standby data 206 now does correspond to the version of the standby key 204_{STANDBY} stored in the memory 42, which means that both network entities 12, 14 maintain the same standby key 204_{STANDBY} (which is “fresh”) from time TE onwards. This will cause the sub-function (i) to declare a standby key match condition, which opens the door to triggering rollover by the controller 44 and the controller 44*. Specifically, under a first option, rollover can be triggered at a time following time TE by entry of a command from an operator who has refreshed the standby key 204_{STANDBY} at both the first and second network entities 12, 14 and who has subsequently witnessed the standby key mismatch condition turn into the standby key match condition (which occurs at time TE). Under a second option, a software functional element that was responsible for refreshing the standby key 204_{STANDBY} at both the first and second network entities 12, 14 can monitor the standby key mismatch condition and automatically trigger rollover anytime after it detects the standby key match condition (which occurs at time TE). Still other possibilities involving manual and/or automatic rollover procedures are within the scope of the present invention.

In the above first specific embodiment, when both network entities 12, 14 were found to maintain the same standby key 204_{STANDBY} from time TC onwards, the contents of BANK A (i.e., containing the standby key 204_{STANDBY}) was refreshed with a brand new value (e.g., to “00000000”). However, it should be appreciated that in a second specific embodiment, the contents of BANK A can actually be refreshed with the contents of BANK B (containing the active key 204_{ACTIVE}) very shortly after the previous rollover. In this way, both BANK A and BANK B will hold the same key until software or a user decide that it is time to roll the key over again.

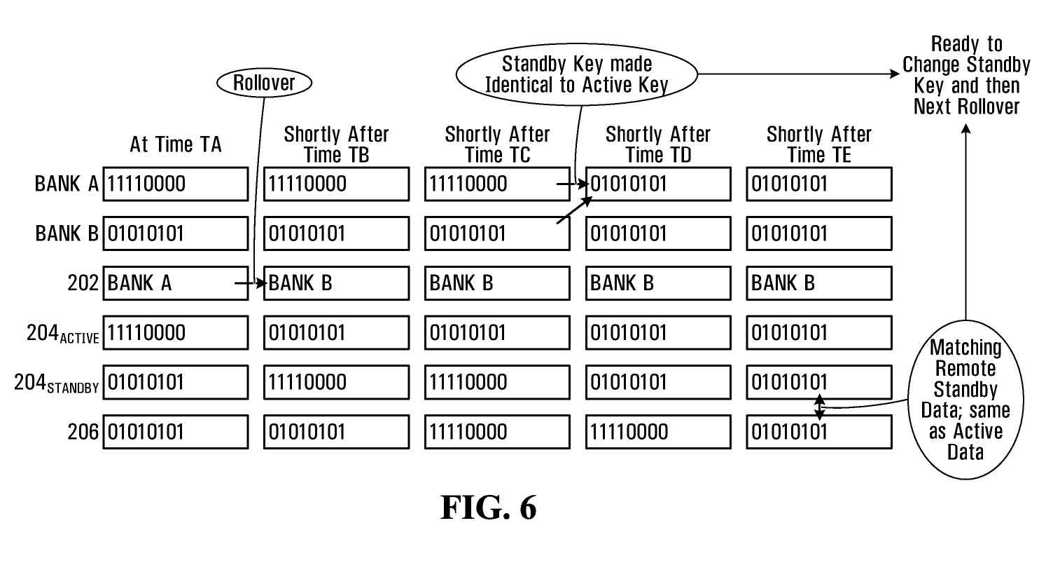

In particular, consider that at time TD the controller 44 automatically changes the contents of BANK A so that it holds what is currently held in BANK B, namely “01010101”. Thus, with reference to FIG. 6 (which is identical to FIG. 4 up until time TD), the memory 42 contains the following information shortly after time TD:
BANK A=01010101;
BANK B=01010101;
active key bank designator 202=BANK B;
active key 204_{ACTIVE}=*BANK B=01010101;
standby key 204_{STANDBY}=*BANK A=01010101;
remote standby data 206=11110000.

It is noted that the remote standby data 206 for the time being no longer corresponds to the version of the standby key 204_{STANDBY} stored in the memory 42. Thus, the sub-function (i) described above will declare a standby key mismatch condition, although this condition may be very short-lived and may not persist for very long. This is because in this second specific embodiment, the standby key 204_{STANDBY} is changed at the second network entity 14 in an automatic fashion as well. Indeed, assume that the contents of BANK A in the memory 42* at the second network entity 14 is modified. Shortly thereafter, the control messages 310 issued by the controller 44* will contain the version of the standby key 204_{STANDBY} stored in the memory 42* at the second network entity 14. This data is received by the first network entity 12 and stored as the remote standby data 206 in the memory 42 upon receipt at time TE. Thus, with reference again to FIG. 4, the memory 42 contains the following information shortly after time TE:
BANK A=01010101;
BANK B=01010101;
active key bank designator 202=BANK B;
active key 204_{ACTIVE}=*BANK B=01010101;
standby key 204_{STANDBY}=*BANK A=01010101;
remote standby data 206=01010101.

It is noted that the remote standby data 206 now does correspond to the version of the standby key 204_{STANDBY} stored in the memory 42, which means that both network entities 12, 14 maintain the same standby key 204_{STANDBY} (which is the same as the active key 204_{ACTIVE}) from time TE onwards. This will cause the sub-function (i) to declare a standby key match condition, which opens the door to triggering rollover by the controller 44 and the controller 44*. Now, because the standby key 204_{STANDBY} is the same as the active key 204_{ACTIVE}, rollover requires that the standby key 204_{STANDBY} be refreshed with a brand new value for security reasons at both the first and second network entities 12, 14, which may involve manual and/or automatic procedures.

In both of the above scenarios, refreshing the standby key 204_{STANDBY} at one network entity with a new value causes the occurrence of a standby key mismatch condition, which requires that the standby key 204_{STANDBY} also be refreshed at the other network entity, at which point it is suitable to trigger rollover. Meanwhile, encrypted data continues to flow (based on encryption using the active key 204_{ACTIVE}), and therefore rollover does not have an impact on the traffic flow, i.e., rollover can be said to be “hitless”. This can be advantageous for many reasons, including:
There is no disruption to service, which allows throughput to be maintained and also prevents the network from unnecessarily taking action (re-computing routes, etc.) which could otherwise result from service disruption;
Service Level Agreements are honored with respect to transmission performance; and
Higher-level applications are unaware that anything has happened.

It should be appreciated that the frequency with which the standby key is changed and rollover triggered will determine the level of security attained. Generally, it will be appreciated that more frequent rollover will lead to greater security, assuming of course that the standby key is kept fresh by changing it before each rollover.

Although the above examples have considered the context of communication in the direction from client 22 to client 32, it should be appreciated that an analogous description applies in the context of communication in any direction between any two clients, including in the opposite direction from client 32 to client 22.

It should further be appreciated that using certain embodiments of the present invention, the data network(s) 18 separating the first network entity 12 and the second network entity 14 can be friendly to a competitor or publicly accessible, without impact on data security or transmission rate.

Those skilled in the art will appreciate that in some embodiments, the functionality of the encryption/encoding module 40, decryption/decoding module 40* and controllers 44, 44* may be implemented using pre-programmed hardware or firmware elements (e.g., application specific integrated circuits (ASICs), electrically erasable programmable read-only memories (EEPROMs), etc.), or other related components. In other embodiments, the functionality of the encryption/encoding module 40, decryption/decoding module 40* and controllers 44, 44* may be achieved using a computing apparatus that has access to a code memory (not shown) which stores computer-readable program code for operation of the computing apparatus, in which case the computer-readable program code could be stored on a medium which is fixed, tangible and readable directly by the encryption/encoding module 40, decryption/decoding module 40* and controllers 44, 44*, (e.g., removable diskette, CD-ROM, ROM, fixed disk, USB drive), or the computer-readable program code could be stored remotely but transmittable to the encryption/encoding module 40, decryption/decoding module 40* and controllers 44, 44* via a modem or other interface device (e.g., a communications adapter) connected to a network (including, without limitation, the Internet) over a transmission medium, which may be either a non-wireless medium (e.g., optical or analog communications lines) or a wireless medium (e.g., microwave, infrared or other transmission schemes) or a combination thereof.

While specific embodiments of the present invention have been described and illustrated, it will be apparent to those skilled in the art that numerous modifications and variations can be made without departing from the scope of the invention as defined in the appended claims.

What is claimed is:

1. A method executed by a first network entity in communication with a second network entity, comprising:
maintaining a first key bank containing a key designated as an active key for the first network entity;
maintaining a second key bank containing a key designated as a standby key for the first network entity;
encrypting data for transmission to the second network entity using the active key for the first network entity;
attempting to detect a match between (i) a representation of the standby key for the first network entity and (ii) a representation of a standby key for the second network entity received from the second network entity; and
upon detecting a match, causing the active key for the first network entity to designate thereafter the key contained in the second key bank.

2. The method defined in claim 1, wherein said causing is effected automatically through software.

3. The method defined in claim 1, wherein said causing is effected by entry of a user command.

4. The method defined in claim 1, further comprising:
refreshing the standby key for the first network entity and the standby key for the second network entity;
wherein said attempting to detect comprises processing control messages received from the second network entity after said refreshing.

5. The method defined in claim 4, wherein said refreshing comprises entry of user input.

6. The method defined in claim 4, wherein said refreshing comprises effecting a remote login procedure.

7. The method defined in claim 4, wherein said refreshing is effected autonomously through software.

8. The method defined in claim 4, wherein the control messages contain a data element that is the standby key for the second network entity.

9. The method defined in claim 8, wherein said attempting to detect a match comprises (i) extracting from the control messages the data element; and (ii) comparing the data element to the standby key for the first network entity.

10. The method defined in claim 4, wherein the control messages contain a data element that is a version of the standby key for the second network entity having been subjected to a hash function.

11. The method defined in claim 10, wherein said attempting to detect a match comprises (i) extracting from the control messages the data element; (ii) applying said hash function to the standby key for the first network entity; and (iii) comparing the data element to the result of the hash function.

12. The method defined in claim 4, wherein the control messages contain a data element that is a version of the standby key for the second network entity having been subjected to a self-encryption function.

13. The method defined in claim 12, wherein said attempting to detect a match comprises (i) extracting from the control messages the data element; (ii) applying the self-encryption function to the standby key for the first network entity; and (iii) comparing the data element to the result of the self-encryption function.

14. The method defined in claim 4, further comprising sending a challenge to the second network entity, the challenge comprising a plaintext random number, wherein the control messages contain a data element that is a version of the plaintext random number having been subjected to encryption using the standby key for the second network entity

15. The method defined in claim 14, wherein said attempting to detect a match comprises (i) extracting from the control messages the data element; (ii) decrypting the data element using the standby key for the first network entity, thereby to produce an outcome; and (iii) comparing the outcome to the plaintext random number.

16. The method defined in claim 4, further comprising sending a challenge to the second network entity, the challenge comprising a version of a plaintext random number having been subjected to encryption with the standby key for the first network entity, wherein the control messages contain a data element that is a version of the encrypted plaintext random number having been subjected to decryption with the standby key for the second network entity.

17. The method defined in claim 16, wherein said attempting to detect a match comprises (i) extracting from the control messages the data element; and (iii) comparing the data element to the plaintext random number.

18. The method defined in claim 1, further comprising:
receiving input data;
outputting a stream of data elements, each having a header and a payload, wherein the payload comprises (i) a first segment comprising the input data encrypted using the active key for the first network entity and (ii) a second segment comprising an indication of the key bank that contains the active key for the first network entity.

19. The method defined in claim 18, further comprising:
generating second control messages comprising a representation of the standby key for the first network entity; and
transmitting the second control messages to the second network entity.

20. The method defined in claim 19, wherein the second control messages are interspersed among the data elements in the stream.

21. The method defined in claim 18, further comprising:
generating second control messages comprising a representation of the active key for the first network entity; and
transmitting the second control messages to the second network entity.

22. The method defined in claim 21, wherein the second control messages are interspersed among the data elements in the stream.

23. The method defined in claim 1, further comprising:
attempting to detect a match between (i) a representation of the active key for the first network entity and (ii) a representation of an active key for the second network entity received from the second network entity;
upon detecting a mismatch, signaling a potential malfunction.

24. The method defined in claim 23, wherein said attempting to detect comprises processing control messages received from the second network entity.

25. The method defined in claim 1, wherein upon detecting a mismatch, signaling occurrence of a standby key mismatch condition.

26. The method defined in claim 1, further comprising, after said causing:
continuing to encrypt data for transmission to the second network entity using the active key for the first network entity, wherein the active key for the first network entity now designates the contents of the second key bank.

27. The method defined in claim 26, wherein upon detecting a match, said method further comprises causing the standby key for the first network entity to designate thereafter the key contained in a key bank other than the second key bank.

28. The method defined in claim 27, wherein said key bank other than the second key bank comprises the first key bank.

29. The method defined in claim 27, further comprising:
maintaining a third key bank;
wherein said key bank other than the second key bank comprises the third key bank.

30. A first network entity for communication with a second network entity, comprising:
a first key bank containing a key designated as an active key for the first network entity;
a second key bank containing a key designated as a standby key for the first network entity;
an encryption module configured to encrypt data for transmission to the second network entity using the active key for the first network entity; and
a controller configured to detect a match between (i) a representation of the standby key for the first network entity and (ii) a representation of a standby key for the second network entity received from the second network entity;
wherein upon detecting a match, the controller is configured to cause the active key for the first network entity to designate thereafter the key contained in the second key bank.

31. A first network entity for communication with a second network entity, comprising:
means for maintaining a first key bank containing a key designated as an active key for the first network entity;
means for maintaining a second key bank containing a key designated as a standby key for the first network entity;
means for encrypting data for transmission to the second network entity using the active key for the first network entity;
means for detecting a match between (i) a representation of the standby key for the first network entity and (ii) a representation of a standby key for the second network entity received from the second network entity; and
means for responding to detection of a match by causing the active key for the first network entity to designate thereafter the key contained in the second key bank.

32. A computer-readable medium comprising computer-readable program code which, when interpreted by a computing entity, causes the computing entity to execute a method of communicating with a second network entity, the computer-readable program code comprising:
first computer-readable program code for causing the computing entity to maintain a first key bank containing a key designated as an active key for the first network entity;
second computer-readable program code for causing the computing entity to maintain a second key bank containing a key designated as a standby key for the first network entity;
third computer-readable program code for causing the computing entity to encrypt data for transmission to the second network entity using the active key for the first network entity;
fourth computer-readable program code for enabling the computing entity to detect a match between (i) a representation of the standby key for the first network entity and (ii) a representation of a standby key for the second network entity received from the second network entity; and
fifth computer-readable program code for causing the computing entity to respond to detection of a match by causing the active key for the first network entity to designate thereafter the key contained in the second key bank.

33. A system, comprising:
a first network entity; and
a second network entity communicatively coupled to the first network entity;
the first network entity comprising:
a first key bank containing a key designated as an active key for the first network entity;
a second key bank containing a key designated as a standby key for the first network entity; and
an encryption module configured to produce a stream of data elements for the second network entity, each data element having a header and a payload, wherein the payload comprises (i) a first segment comprising input data encrypted using the active key for the first network entity and (ii) a second segment comprising an indication of the key bank that contains the active key for the first network entity;
the second network entity comprising:
a third key bank corresponding to the first key bank in the first network entity;
a fourth key bank corresponding to the second key bank in the first network entity; and
a decryption module configured to process the stream of data elements from the first network entity to determine the contents of the respective second segments and to decrypt the respective first segments using the contents of the respective first segments, thereby to recover the input data.

34. The system defined in claim 33, wherein the third key bank contains a key designated as an active key for the second network entity and wherein the fourth key bank contains a key designated as a standby key for the second network entity, and wherein the second network entity further comprises:
a controller configured to produce a representation of the standby key for the second network entity and to generate control messages for the first network entity containing said representation of the standby key for the second network entity.

35. The system defined in claim 34, wherein the first network entity further comprises:
a controller configured to process the control messages in order to obtain the representation of a standby key for the second network entity; and
detect a match between (i) a representation of the standby key for the first network entity and (ii) the representation of a standby key for the second network entity, wherein upon detecting a match, the controller is configured to cause the active key for the first network entity to designate thereafter the key contained in the second key bank.

36. The system defined in claim 35, wherein the first and second network entities communicate over a public packet-switched network.
